(19) United States
(12) Patent Application Publication
(10) Pub. No.: US 2018/0236841 A1
(43) Pub. Date: Aug. 23, 2018

(54) Air-Conditioning Device and Method for Operating Same

(71) Applicant: Bayerische Motoren Werke Aktiengesellschaft, Muenchen (DE)

(72) Inventors: Robert HERBOLZHEIMER, Groebenzell (DE); Oliver HORN, Muenchen (DE); Thorsten MOCKENHAUPT, Muenchen (DE); Andreas KROMPASS, Simbach am Inn (DE)

(21) Appl. No.: 15/958,099

(22) Filed: Apr. 20, 2018

Related U.S. Application Data
(63) Continuation of application No. PCT/EP2016/074453, filed on Oct. 12, 2016.

(30) Foreign Application Priority Data
Oct. 21, 2015 (DE) 10 2015 220 465.0

(51) Int. Cl. B60H 1/00

(52) U.S. Cl. CPC B60H 1/00064; B60H 1/00835

(57) ABSTRACT

An air-conditioning device for air-conditioning a passenger compartment is provided. The air-conditioning device includes a cooling element for cooling air, an air duct downstream of the cooling element for guiding the air, a heating element downstream of the air duct for warming the air, a mixing zone downstream of the heating element, and multiple air outlets for discharging multiple partial air streams from the mixing zone into different regions of the passenger compartment. An additional cold air bypass is formed which is guided past the heating element for supplying additional cold air downstream of the heating element. As a result, the air-conditioning device in operation is particularly efficient and simultaneously simple in design and particularly cost-effective. Furthermore, the invention provides a method for operating the air-conditioning device.

### CROSS REFERENCE TO RELATED APPLICATIONS

This application is a continuation of PCT International Application No. PCT/EP2016/074453, filed Oct. 12, 2016, which claims priority under 35 U.S.C. § 119 from German Patent Application No. 10 2015 220 465.0, filed Oct. 21, 2015, the entire disclosures of which are herein expressly incorporated by reference.

### BACKGROUND AND SUMMARY OF THE INVENTION

The invention relates to an air conditioning unit for the air conditioning of a passenger compartment. The air conditioning unit includes a cooling element for the cooling of air, an air duct downstream of the cooling element for the guidance of the air, and a heating element downstream of the air duct for the warming of the air. Further, the air conditioning unit includes a mixing zone downstream of the heating element and a plurality of air outlets for discharging a plurality of partial air streams from the mixing zone into different regions of the passenger compartment.

Such an air conditioning unit is described, for instance, in DE 10 2007 014 835 B4.

An air conditioning unit regularly serves for the air conditioning of the passenger compartment of a vehicle. To this end, the passenger compartment is fed air, which is cooled or heated by way of the air conditioning unit. The air is either extracted as fresh air from the surroundings of the vehicle, or is extracted as circulating air from the passenger compartment and then recirculated. In the air conditioning unit, a cooling of the air is typically realized by way of an air conditioning evaporator, which is connected to a refrigerating circuit and in which, for the absorption of heat, refrigerant is evaporated. For the heating of air, the air conditioning unit usually has a heating heat exchanger, which is connected to a coolant circuit and is flowed through by warm coolant, for instance water.

For increased comfort, it is possible to stream the air into the passenger compartment on different ventilation planes, i.e., into different regions of the passenger compartment, at respectively different temperature. Thus it is frequently felt to be more agreeable if air which has been streamed in at chest height is a few degrees colder than air streamed into the footwell. To this end, it is conceivable, with a view to an active stratification, to split the air stream spatially into a plurality of partial air streams and to warm or cool them differently, before these partial air streams are then respectively streamed into the passenger compartment. Such a solution requires, however, a multiplicity of additional final control elements, i.e., motors or, in general terms, actuators, and is therefore usually expensive.

In DE 10 2007 014 835 B4 is described an air conditioning unit in which air flows through a heating heat exchanger which has two cold air passages and which is arranged such that, downstream of this same, a temperature-stratified air flow is present, the layers of which are assigned to various air outlets. As a result, air with different temperature can flow into the passenger compartment via different outlets.

Against this background, an object of the invention is to define an improved air conditioning unit which ensures enhanced comfort in the air conditioning of a passenger compartment of a vehicle and, at the same time, is as cost-effective and efficient as possible. Furthermore, the air conditioning system should be suitable, in particular, for use in an electrical or hybrid vehicle and, in addition, to be as energy efficient as possible during operation. Furthermore, a method for operating the air conditioning unit should be defined.

This and other objects are achieved by an air conditioning unit and by a method for operating such an air conditioning unit in accordance with embodiments of the invention. Advantageous embodiments, refinements and variants are also provided. Here, the statements made in connection with the air conditioning unit apply analogously also to the method, and vice versa.

The air conditioning unit is configured for the air conditioning of a passenger compartment, i.e., for use in a vehicle. The air conditioning unit includes a cooling element for the cooling of air, an air duct downstream of the cooling element for the guidance of the air, a heating element downstream of the air duct for the warming of the air, a mixing zone downstream of the heating element, and a plurality of air outlets for discharging a plurality of partial air streams from the mixing zone into different regions of the passenger compartment. According to an embodiment of the invention, an additional cold air bypass is formed, which is guided past the heating element, for supplying additional cold air downstream of the heating element.

The invention is based on the consideration that, in an optimally cost-effective air conditioning unit for generating a plurality of partial air streams with different temperatures, an active stratification with additional final control elements, and a respectively separate, active air conditioning of the various partial air streams, are dispensed with. Instead, the mixing zone in which the air component cooled by the evaporator and the air component heated by the heating element meet is designed such that downstream of the mixing zone an air stream, i.e., here, in particular, a total air stream, with a temperature gradient or with a plurality of temperature zones of different temperature, is obtained. Downstream of the heating element, there is thus formed in the mixing zone a stratified air stream, which in different regions, i.e., spatial regions, also has different temperatures. Through suitable arrangement of the air outlets, a plurality of partial air streams with different temperatures can then be generated. Usually, three partial air streams are generated, for three regions of the passenger compartment, which are also termed ventilation planes, namely respectively a partial stream for the footwell, at chest height of the occupant, and along the windscreen.

However, the above-described stratified air stream requires strong heating by way of the heating element, since, if the temperature of the heating element is too low, not enough cold air can be introduced into the mixing zone to generate a stratification. In order to produce a suitable stratification, temperatures of, e.g., 80° C. or more at the heating element are frequently necessary. A correspondingly high energy requirement is thereby obtained. This is critical in particular in an electrical or hybrid vehicle which is primarily driven by way of a high-voltage battery and an electrical drive train, since here no permanently operated internal combustion engine is available and generates heat, but instead additional heat has to be supplied via electric auxiliary heaters. The energy which is necessary for this is then drawn directly from the high-voltage battery, which has a direct negative effect on the range of the vehicle. The necessary high temperature in the use of a heat pump for heating the vehicle interior has a particularly adverse effect.

A central idea of the invention now consists in particular in supplying additional cold air, in an cost-effective air conditioning unit without active stratification, in order to generate partial air streams with different temperature, so that the need for an air stream which is stratified by way of the heating element in the mixing zone is eliminated. To this end, additional cold air is conducted via the cold air bypass past the heating element and, in particular, also past the mixing zone, i.e., is not warmed, and downstream of this same is fed to the air in order to generate a suitable temperature difference. The heating element is then advantageously operated precisely at that temperature, i.e., a corresponding operating point, which is necessary specifically to reach the desired temperature of the warmest of the partial air streams, in particular that into the footwell. An inefficient operation above this minimally required temperature of the heating element is avoided. The temperature difference in the colder partial air stream is then adjusted by the supply, i.e., admixture, of the additional cold air.

The cold air bypass is in particular spatially separated from the air duct, so that no interaction, i.e., no temperature exchange between the cold air and that air which is conducted further through the air duct and into the mixing zone, takes place. To this end, the air and the cold air are conducted, for instance, through separate ducts or, at least are spatially separated from each other by a wall.

In a suitable embodiment, the heating element is configured as a heating heat exchanger, for the exchange of heat between a coolant and air. The air conditioning unit then in particular has a cooling circuit, to which the heating element is connected and from which heat is fed to the heating element. In a suitable alternative, the heating element is a heat pump condenser or a gas cooler of the air conditioning unit, and is then, in particular, connected to a refrigerating circuit of the air conditioning unit. In general terms, the heating element is in particular a heat exchanger, thus transfers heat between two heat mediums, in contrast to an electrical heating element.

In a suitable embodiment, the cooling element is configured as an air conditioning evaporator and is connected to the refrigerating circuit of the air conditioning unit, via which circuit heat is then removed, which heat is absorbed by the cooling element. In a variant, an in particular indirect cooling is realized by way of a secondary circuit, i.e., a secondary cooling circuit. To this end, the cooling element is configured, for instance, as a heat exchanger, which is connected to the secondary circuit. Similarly to the heating element, the cooling element too is generally in particular a heat exchanger, for the transfer of heat between two heat mediums.

The refrigerating circuit includes in particular also a heat pump, which serves for the supply of heat to the heating element. Such a heat pump enables a particularly efficient distribution of heat from different parts and components of the vehicle which are connected to the refrigerating circuit or the cooling circuit. In particular, from such components which constitute a heat source, heat is then conducted by way of the heat pump to the heating element, which, to this effect, is then linked as a heat sink to the heat pump. The heat pump is in particular a part of the air conditioning unit and usually has an evaporator, a condenser and a compressor, which are respectively connected to the refrigerating circuit. The condenser is then regularly a water-cooled condenser, which is appropriately cooled via the cooling circuit and delivers heat thereto. In order from the condenser to then relay heat to the heating element, this is expediently arranged in the cooling circuit downstream of the condenser.

In principle, it is also contemplated that as the heating element an electrical heating element is used, or that an electrical auxiliary heater is connected upstream of the heating element in the coolant circuit. Preferably, in the air conditioning unit, any electrically operated auxiliary heaters and heating elements are dispensed with, however, and instead only waste heat from vehicle components or from the environment is used, whereby the air conditioning unit is then particularly energy efficient. Particularly preferred and efficient is a heat supply to the heating element by way of a heat pump.

Via the cold air bypass, a specific quantity of cold air is supplied. The air conditioning unit now suitably has a cold air metering element, for adjusting the quantity of cold air which is supplied through the cold air bypass, i.e., for the metering of cold air. The cold air metering element is, for instance, a bypass flap, which is then also referred to as a stratification flap, which is pivotably mounted and enables a change of cross-section in the cold air bypass. In the closed state, no cold air is then conducted; in the open state, a certain quantity of cold air is supplied, depending on the setting of the cold air metering element. In addition, downstream of the cooling element is herein arranged a mixing air metering element, for adjusting a warm air component which is conducted via the heating element and for adjusting a cooling air component which is guided past the heating element, i.e., in general terms, for the metering of the mixing air. Analogously to the cold air metering element, the mixing air metering element serves to realize a change of cross section. The mixing air metering element thus substantially determines the temperature of the air in the mixing zone. For instance, the mixing air metering element is a mixing air flap, or a combination of a plurality of flaps, which guides a correspondingly adjustable share of the air from the air duct via or through the heating element. By way of the cold air metering element, the quantity of air which is conducted via the cold air bypass is then adjustable. By way of the mixing air metering element, the quantity of air which is conducted via the cold air bypass is then adjustable. By contrast, by way of the mixing air metering element, the quantity of air which flows into the mixing zone, as well as, in particular, also the temperature of the air in the mixing zone, is adjustable.

In a particularly preferred embodiment, the air conditioning unit is configured such that the cold air metering element and the mixing air metering element are adjusted by way of just one common final control element. By final control element is here understood, in particular, an active element, i.e., an actuator, in particular a motor, also termed an adjusting motor, preferably a stepping motor, or alternatively, for instance, a servomotor. Both metering elements, i.e., the cold air metering element and the mixing air metering element, are consequently driven and adjusted by way of the same final control element. This final control element is in particular also the sole final control element, which adjusts the two metering elements. This embodiment is particularly cost-effective, since an additional final control element for the cold air bypass is dispensed with and accordingly is not present. For the optimal setting of the different temperatures of the plurality of partial air streams, rather a single final control element for the involved metering elements is adequate. The final control element has, for instance, a cam disk, which is controlled via a servomotor and by way of which the two metering elements are then adjusted.

Suitably, the final control element has two working ranges, also referred to as adjustment ranges, namely a first working range, in which the mixing air metering element is adjusted, and a second working range, in which the cold air metering element is adjusted. In the case of a stepping motor, for instance different angular ranges of a complete revolution are then used to control and to adjust the different metering elements. In general terms, in the embodiment including two working ranges, the two metering elements are then nevertheless able to be adjusted to a certain extent independently of each other by way of the same final control element. Upon an actuation of the final control element on a respective working range or adjustment along this working range, only that air stream which is adjustable via the associated metering element is adjusted and altered. Thus, the cross-section is altered either in the cold air bypass or in the air duct, but not in both at the same time. For instance, on a respective working range, only the associated metering element is adjusted, while the other metering element remains in a specific rest setting. In principle, it is also possible, however, for both metering elements to perform a movement simultaneously, though in this case only one of these movements actually shows an effect with respect to the respective air stream.

In a particularly preferred embodiment, the cold air metering element and the mixing air metering element are mechanically coupled to each other, i.e., with a mechanical coupling. The two metering elements are here adjusted jointly, but not necessarily simultaneously. In other words, the metering elements are connected to each other via a delayed coupling, also kinematics. The mechanical coupling is, for instance, a common connection to the final control element. Alternatively, a gear mechanism, by way of which a switch is made between the two metering elements, is also contemplated, so that although both are driven by the same final control element, only one is adjusted with the final control element. In an exemplary, suitable embodiment, the kinematics are realized by way of a cam disk, which adjusts both metering elements. The cam disk itself is driven, for example, by a motor. Specially configured coupling kinematics, which via suitable levers and bearing points realize the appropriate adjustability, are also contemplated, however. In general terms, by the mechanical coupling, it is in particular ensured that both metering elements are adjustable, and also adjusted, via the same final control element, even if not necessarily at the same time.

The mechanical coupling is based in particular on the idea that the additional cold air is necessary only in specific situations, namely in particular when the adjustment options by way of the mixing air metering element are exhausted. The particular coupling advantageously enables an adjustment of the metering elements such that the one metering element is only adjusted once a concrete air conditioning requirement, in particular a temperature difference between the partial air streams, can no longer be served by the other metering element. For instance, an attempt is firstly made by way of the mixing air metering element to obtain a desired air conditioning of the passenger compartment. If, however, within the scope of the adjustment options of the mixing air metering element, no suitable stratification is possible and no suitable temperature difference between the partial streams can be produced, then the cold metering element is used instead. By way of the cold air bypass, an extended range of adjustment, so to speak, of the air conditioning unit with regard to an optimally comfortable air conditioning of the passenger compartment is thus realized.

In a suitable embodiment, the mixing air metering element has an end position, and the cold air metering element is only opened and adjusted once the mixing air metering element is set in the end position. The end position of the mixing air metering element is in this case in particular a position in which a maximum quantity of air from the air duct is warmed by way of the heating element. Where one or more flaps are used for the mixing air metering element, the end position marks, in particular, a stop beyond which the flap or flaps cannot further be moved. In the mixing zone no stratification can then be obtained, since all the air which is fed to the mixing zone is warmed equally by way of the heating element. In this case, a separate supply of cold air is then particularly sensible in order to be at all able to efficiently generate partial air streams with different temperatures. An inefficient increase in temperature of the heating element is then spared.

In order to be able to generate a stratified air stream already in the mixing zone, the heating element expediently projects only partially into the air duct. In the air duct, in particular two paths for the air are thereby obtained, namely a first path through the heating element and a second path past this same. The two paths are here structurally separated from each other merely in such a way that, in particular by adjustment of the mixing air metering element, the air stream can be differently split amongst the two paths, whereby then, depending on the setting, a corresponding temperature of the air in the mixing zone is generated. A specific cross-section of the air duct remains free, however, from the heating element and then serves to relay the cooling air component of the air.

Preferably, the generation of a stratified air stream in the mixing zone as a result of an increase in temperature at the heating element is dispensed with, and by way of this latter the air is warmed to maximally about 50° C. As a result, the air conditioning unit is consistently operated in a particularly efficient low-heating mode and is particularly suitable for use in a vehicle having a heat pump, i.e., a vehicle in which heat is fed to the heating element by way of a heat pump. The efficiency of the heat pump typically markedly decreases with rising temperature at the heating element and, particularly in the region above about 50° C., experiences a significant drop, particularly in combination with external temperatures between −7 and 0° C. which are customary in winter in Central Europe. In one possible variant, the heat which is used for the heating is extracted from the surroundings of the vehicle via an ambient cooler, so that, when the heat pump is under high load in order to achieve a high temperature of the heating element, the risk of icing exists in heightened measure at the ambient cooler. Since now, due to the separate cold air supply via the cold air bypass for increased comfort, a stratification by way of the heating element is no longer necessary, it is possible to operate this latter at a correspondingly low temperature, i.e., maximally about 50° C., and thus to operate the heat pump in a consistently efficient manner, even given the above-described, low external temperatures.

The cold air is preferably extracted from the air downstream of the cooling element and upstream of the heating element, i.e., the cold air bypass begins at the air duct, and channels off from this latter air which has previously been cooled at the cooling element. In this way, the cold air has a defined temperature. In principle, it is also contemplated, however, to extract the cold air as fresh air directly from the surroundings of the vehicle. In order to obtain an air conditioning unit which is as cost-effective as possible, preferably no separate cooling of the cold air takes place in the cold air bypass.

Preferably, the cold air is then fed downstream of the mixing zone directly to one of the partial air streams, in particular to that partial stream which is then streamed into the passenger compartment at chest height of a potential occupant. In this embodiment, the cold air bypass thus emerges, for instance, in one of the air outlets, which channels off the appropriate partial air stream from the mixing zone and feeds it to one of the ventilation planes. In an, in principle, likewise suitable variant, the cold air, however, is streamed into the mixing zone in order in this way to form there a stratified air stream, which is subsequently split into a plurality of partial air streams.

In a preferred embodiment, the air conditioning unit can be operated in summer mode and in winter mode and has a control unit, also referred to as a controller, which is configured such that the cold air metering element in summer mode is completely closed and only in winter mode is set to supply the additional cold air via the cold air bypass. To this end, the control unit controls in particular the final control element, to be precise preferably in dependence on an air conditioning requirement and/or the external temperature. In summer mode, a mixing of warm air component and cooling air component then takes place according to requirement in the mixing zone, in which case respectively a cooling air component of the air stream in the air duct is guided past the heating element by way of the mixing air metering element, while a remaining warm air component is warmed. The cold air bypass is in this case completely closed. The cold air bypass is hence used primarily in winter mode, in order to generate, in particular under maximum heating by way of the heating element, a further temperature difference between the different partial air streams. The cold air bypass herein enables in particular an extension, so to speak, of the winter mode, such that, despite complete heating of the air in the air duct, and thus an accompanying loss of a stratification in the mixing zone, partial air streams with different temperatures are still generated.

In an advantageous variant, the cold air bypass is used, however, also in summer mode, i.e., in summer mode additional cold air is supplied via the cold air bypass. In this case, it is then possible to set a lower temperature at the heating element, and yet to obtain an advantageous temperature difference between the partial air streams, thus, for example, the footwell and the ventilation at chest height. In this case, in particular also the heat pump is then operated at lower power. Through the use of additional cold air in summer mode, the efficiency of the air conditioning unit is thus improved overall.

Expediently, for the suitable setting of the temperature difference, the cold air metering element is regulated by way of the control unit. As the control variable, the temperature difference, for instance, is used, or a predefined blow-out temperature. Also the mixing air metering element is expediently regulated in corresponding manner.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of an air conditioning unit.

FIG. 2 is a diagram showing an adjustment characteristic for metering elements of the air conditioning unit.

### DETAILED DESCRIPTION OF THE DRAWINGS

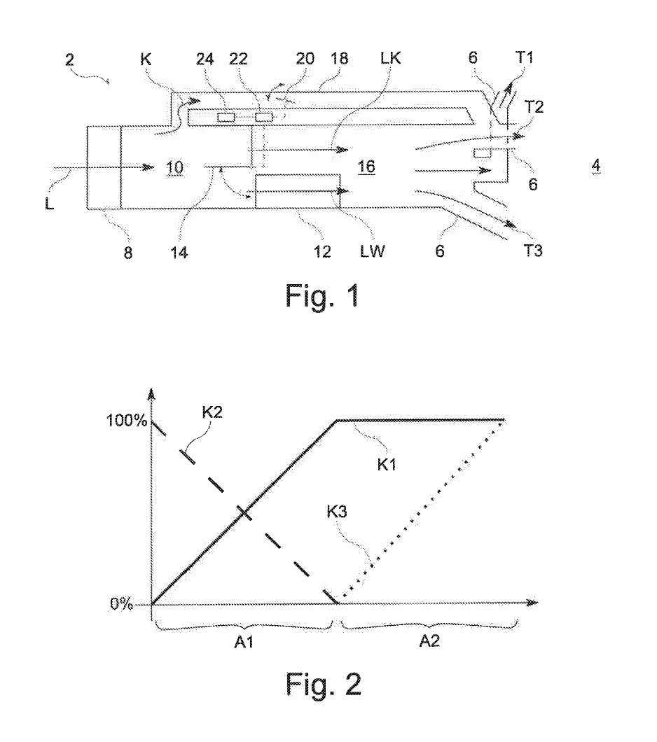

In FIG. 1, an air conditioning unit 2, which serves for the air conditioning of a passenger compartment 4 of a vehicle (not shown in detail), is represented in schematized representation. In this context, a partial air stream T1, T2, T3 is respectively streamed into a plurality of regions of the passenger compartment 4 via air outlets 6. These partial air streams serve for the air conditioning of the different regions, which are also referred to as ventilation planes. Thus, in the illustrative embodiment which is shown here, the partial stream T1 is conducted along a windscreen (not represented in detail) of the vehicle, the partial stream T2 is discharged approximately at the chest height of an occupant (not shown), and the partial stream T3 into a footwell of the vehicle. In order to increase the comfort, the partial air streams T1, T2, T3 are temperature-controlled differently, i.e., have different temperatures. At least, in the illustrative embodiment which is shown here, the partial air stream T2 is a few ° C. cooler than the two other partial air streams T1, T3. For instance, the partial air stream T3 for the footwell may have a temperature of about 45° C., and the partial air stream T2 at the chest height of an occupant only about 35° C. The partial air stream T1 may have, for instance, likewise a temperature of 45° C.

For the air conditioning, air L is firstly streamed into or drawn into the air conditioning unit 2 and initially passes through a cooling element 8, which serves to cool the air L and is connected to a refrigerating circuit (not shown) of the air conditioning unit 8. Downstream of the cooling element 8, the air L is conducted through an air duct 10 to a heating element 12, which serves to warm the air L and which is here configured as a heating heat exchanger, which is connected to a coolant circuit (not shown). In FIG. 1, the heating element projects only partially into the air duct 10, so that the air can be conducted via two different paths, namely as a cooling air component LK past the heating element 12 and/or as a warm air component LW through the heating element 12.

The air L is here distributed amongst the two paths by way of a mixing air metering element 14. The mixing air metering element 14 is here configured as a mixing air flap, which at the same time adjusts the cooling air component LK and the warm air component LW. However, an embodiment as two separate flaps is also contemplated. Both the cooling air component LK and the warm air component LW make their way downstream of the heating element 12 into a mixing zone 16. Depending on the temperature of the heating element 12, the air L is then here present as a stratified air stream, or the various air components LK, LW mix together. In the case of a stratification, in different regions of the mixing zone 16, partial air streams T1, T2, T3 of different temperature can then be tapped. Such a stratification requires, however, a sufficiently large temperature difference between the cooling air component LK and the warm air component LW, and a strong warming by way of the heating heat exchanger 12, which may then have a temperature of, for instance, up to 80° C., i.e., far above an actually required temperature, for instance the above-mentioned 45° C. However, this is usually detrimental to the efficiency of the air conditioning unit 2 and, in particular, of a heat pump (not shown in detail) of the air conditioning unit 2, which heat pump, inter alia, serves to supply the heating element 12 with heat. This heat pump extracts from the surroundings of the vehicle the heat used for the warming, for instance via an ambient cooler (not shown), and may be operated at particularly high power in the event of strong heating, whereby, correspondingly, the ambient cooler is also at risk of icing. This risk arises particularly at low external temperatures, for instance in the range from −7 to 0° C., i.e., in particular in winter.

In order to operate the air conditioning unit 2 particularly efficiently, however, in particular in winter mode, in the illustrative embodiment which is shown here the maximum temperature of the heating element 12 is limited to about 50° C. In order then however to provide various partial air streams T1, T2, T3 having different temperatures, in particular if there is no stratification of the air L in the mixing zone 16, the air conditioning unit 2 additionally has a cold air bypass 18, for the bypassing of the heating element 12 and for the supply of cold air K downstream of the heating element 12. The cold air K is here, in FIG. 1, extracted from the air L downstream of the cooling element 8. In the embodiment which is shown here, the cold air bypass 18 then opens out directly into one of the air outlets 6, so that the associated partial air stream T2 is additionally cooled and, correspondingly, a temperature difference in relation to the other two partial air streams T1 and T3 is generated. As a result, an increase in comfort is realized even in the here particularly cost-effective, simple and efficient air conditioning unit 2.

For the adjustment of the quantity of cold air K which is supplied, and thus ultimately for the adjustment of the temperature difference, in the cold air bypass 18 is arranged a cold air metering element 20, which is here configured as a bypass flap for opening and closing the cold air bypass 18, wherein intermediate positions are also possible. Usually the cold air metering element 20 is closed, additional cold air K being supplied only as needed. In other words, firstly the air L is appropriately influenced by way of the mixing air metering element 14, and the temperature and, if need be, a stratification in the mixing zone 16, is set. Only in such cases in which no suitable stratification is producible, and in order to operate the air conditioning unit 2, furthermore, as efficiently as possible, the cold air metering element 20 is adjusted. This is here in particular the case when the mixing air metering element 14 assumes an end position as shown in FIG. 1, and the whole of the air L is warmed via the heating element 12. A stratified air stream in the mixing zone 16 is then no longer possible, so that then, correspondingly, cold air K is supplied by adjustment of the cold air metering element 20 and by at least partial opening of the cold air bypass 18.

In order to design the air conditioning unit 2, furthermore, as cost-effectively and simply as possible, the separate controlling and adjustment of the cold air metering element 20 and of the mixing air metering element 14, i.e., of the two metering elements 14, 20, is dispensed with. Instead, both metering elements 14, 20 are adjusted by way of a common final control element 22, which in particular is an actuator, preferably a stepping motor. Here, the two metering elements 14, 20 are mechanically coupled to each other by the final control element 22 in such a way that a delayed adjustment is realized, in which, at a given point in time, only ever one of the metering elements 14, 20 is adjusted. These are thus adjusted in a time-staggered manner, namely specifically such that an actuation by the final control element 22 only leads to an adjustment of the cold air metering element 20 once the mixing air metering element is in the end position. The two metering elements 14, 20 are hence in total connected to each other via delayed kinematics, as discussed in paragraph [0021] above.

The final control element 22 is then configured such that an adjustment characteristic as shown in FIG. 2 is obtained. The adjustment characteristic here shows the setting of the respective metering element 14, 20 as a function of a setting of the final control element 22. The setting of the mixing air metering element 14 is in this case represented by the two characteristic lines K1, K2, wherein the characteristic line K1 shows a setting with respect to the warm air component LW, and the characteristic line K2 a setting with respect to the cooling air component LK. A third characteristic line K3 shows the setting of the cold air metering element 20. Here a setting of 100% corresponds to a complete opening, a setting of 0% corresponds to a closed state.

According to FIG. 2, the final control element 22 has two working ranges A1, A2, namely a first working range A1, in which only the mixing air metering element 14 is adjusted, i.e., a ratio of the air components LK, LW which stream into the mixing zone 16, and a second working range A2, in which only the cold air metering element 20 is adjusted. Here the mixing air metering element 14 is located on the border between the two working ranges A1, A2, and beyond the complete working range A2 in the end position, as illustrated particularly by the characteristic line K1. This juxtaposition of the working ranges A1, A2 is a fundamental feature of the delayed kinematics and of the mechanical and time-staggered coupling of the two metering elements 14, 20 by way of the common final control element 22. It here becomes clear that additional cold air K is only supplied via the cold air bypass 18 once a maximum heating of the air L obtains.

The air conditioning unit 2 further has, as shown in FIG. 1, a control unit 24, which, inter alia, serves to drive the final control element 22. This is driven in particular in dependence on an air conditioning requirement which arises, for instance, from a heating or cooling requirement with respect to the passenger compartment 4 and/or an external temperature, which in particular is an expression of the weather conditions. Depending on the air conditioning requirement, the air conditioning unit 2 is then operated in summer mode or in winter mode.

### REFERENCE SYMBOL LIST

2 air conditioning unit
4 passenger compartment
6 air outlet
8 cooling element
10 air duct
12 heating element
14 mixing air metering element
16 mixing zone
18 cold air bypass
20 cold air metering element
22 final control element
24 control unit
A1 first working range
A2 second working range
K1, K2, K3 characteristic line
L air
LK cooling air component
LW warm air component
T1, T2, T3 partial air stream

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An air conditioning unit for air conditioning of a passenger compartment, comprising:
a cooling element for cooling air;
an air duct downstream of the cooling element for guiding the air;
a heating element downstream of the air duct for warming the air;
a mixing zone downstream of the heating element; and
a plurality of air outlets for discharging a plurality of partial air streams from the mixing zone into different regions of the passenger compartment, wherein
an additional cold air bypass is formed, which is guided past the heating element, for supplying additional cold air downstream of the heating element.

2. The air conditioning unit according to claim 1, further comprising:
a cold air metering element for adjusting a quantity of cold air which is supplied through the cold air bypass, wherein
downstream of the cooling element is arranged a mixing air metering element for adjusting a warm air component which is conducted via the heating element and for adjusting a cooling air component which is guided past the heating element.

3. The air conditioning unit according to claim 2, wherein the cold air metering element and the mixing air metering element are adjusted by way of just one common final control element.

4. The air conditioning unit according to claim 3, wherein
the final control element has two working ranges, which are a first working range, in which the mixing air metering element is adjusted, and a second working range, in which the cold air metering element is adjusted.

5. The air conditioning unit according to claim 2, wherein the cold air metering element and the mixing air metering element are mechanically coupled to each other.

6. The air conditioning unit according to claim 4, wherein the cold air metering element and the mixing air metering element are mechanically coupled to each other.

7. The air conditioning unit according to claim 2, wherein
the mixing air metering element has an end position, and
the cold air metering element is only opened and adjusted once the mixing air metering element is set in the end position.

8. The air conditioning unit according to claim 6, wherein
the mixing air metering element has an end position, and
the cold air metering element is only opened and adjusted once the mixing air metering element is set in the end position.

9. The air conditioning unit according to claim 1, wherein the heating element projects only partially into the air duct.

10. The air conditioning unit according to claim 2, wherein the heating element projects only partially into the air duct.

11. The air conditioning unit according to claim 1, wherein the heating element warms the air to maximally about 50° C.

12. The air conditioning unit according to claim 10, wherein the heating element warms the air to maximally about 50° C.

13. The air conditioning unit according to claim 1, wherein the cold air bypass feeds the cold air downstream of the mixing zone directly to one of the partial air streams.

14. The air conditioning unit according to claim 2, wherein the cold air bypass feeds the cold air downstream of the mixing zone directly to one of the partial air streams.

15. The air conditioning unit according to claim 1, wherein
the air conditioning unit is operable in a summer mode and in a winter mode, and has a control unit which is configured such that the cold air metering element in the summer mode is completely closed and in the winter mode is set to supply the additional cold air via the cold air bypass.

16. The air conditioning unit according to claim 8, wherein
the air conditioning unit is operable in a summer mode and in a winter mode, and has a control unit which is configured such that the cold air metering element in the summer mode is completely closed and in the winter mode is set to supply the additional cold air via the cold air bypass.

17. A method for operating an air conditioning unit with which a passenger compartment is air conditioned, the method comprising the acts of:
feeding air to the passenger compartment;
cooling the air by way of a cooling element;
subsequently conducting the air through an air duct;
subsequently warming the air by way of a heating element;
subsequently conducting the air into a mixing zone;
streaming the air via a plurality of air outlets and in a plurality of partial air streams into different regions of the passenger compartment; and
guiding additional cold air past the heating element via a cold air bypass and supplying the additional cold air downstream of the heating element.
